(19) United States
(12) Patent Application Publication
(10) Pub. No.: US 2006/0047370 A1
(43) Pub. Date: Mar. 2, 2006

(54) Efficient look-ahead load margin and voltage profiles contingency analysis using a tangent vector index method

(75) Inventors: Chia-Chi Chu, Tao-Yuan (TW); Sheng-Huei Lee, Tao-Yuan (TW); Hung-Chi Tsai, Tao-Yuan (TW)

Correspondence Address: NIKOLAI & MERSEREAU, P.A., 900 SECOND AVENUE SOUTH, SUITE 820, MINNEAPOLIS, MN, 55402, US

(73) Assignee: Chang Gung University, Tao-Yuan (TW)

(21) Appl. No.: 10/927,359

(22) Filed: Aug. 26, 2004

(51) Int. Cl. G06G 7/54; H02J 3/00

(52) U.S. Cl. 700/292; 703/18

(57) ABSTRACT

Given the current operating condition at each bus from real-time database, from the short-term load forecast, or from near-term generation dispatch, we present a method for real-time contingency prediction and selection in current energy management systems. This method can be applied to contingency prediction and selection for the near-term power system in terms of load margins to collapse and of the bus voltage magnitudes. The propose algorithm uses only two tangent vectors of power flow solutions and curve fitting based techniques to perform look-ahead load margin and voltage magnitude simultaneously. Therefore, it can overcome the traditional snap-shot contingency analysis methods. Simulations are performed on IEEE 57 and 118-bus test systems to demonstrate the feasibility of this method.

### BACKGROUND OF THE INVENTION

1. Field of the Invention

The present invention relates to an efficient look-ahead load margin and voltage profiles contingency analysis, and more particularly to an efficient look-ahead load margin and voltage profiles contingency analysis that uses a tangent vector index method.

2. Description of Related Art

Contingency analysis is one of the major component in today's modern energy management systems. For the purpose of fast estimating system stability right after outages, the study of contingency analysis involves performing efficient calculations of system performance from a set of simplified system conditions. Generally speaking, the task of contingency analysis can be roughly divided into three phases. Initially, contingency screening will be executed. Low-severe cases will be filtered out from all possible contingencies. Once the contingency screening is finished, severity indices of selected contingencies will then be evaluated. Finally, contingencies are ranked in approximate severity order according to their severity indices. Only contingencies with severe indices will be analyzed in a more comprehensive way.

Traditionally, snap-shot approaches have been widely investigated [reference 5]. This approach can provide system information of normal operating conditions right after faults clearing. Contingency ranking and selection have been developed in the context of determining branch active flow limit or bus voltage limit violations using (DC) analysis [reference 2]. Such method, although fast, is not completely reliable because inaccuracies associated with linear power flows. More recently, developments of contingency analysis have been extended from snap-shot to look-ahead analysis. Look-ahead contingency analysis involves how to predict the near-term load margin ad voltage profiles with respect to voltage collapse points of a large number of post-outage systems. Since a power system continuously experiences load variations or generation rescheduling, look-ahead contingency analysis, an extension of existing snap-shot approach, indeed reflects nonlinear characteristics of power flows and can provide more information about load margin measure and near-term voltage profiles.

In the past, two different approaches have been proposed to study look-ahead contingency analysis: sensitivity-based approach [reference 7], and curve-fitting-based approach [reference 6]. In this paper, an efficient curve-fitting-based algorithm will be developed. Instead of approximating the load margin as a quadratic function of voltage profiles with three unknown coefficients near the collapse point, we re-formulate it as a quadratic function of voltage tangent vector profiles with only two unknown coefficients. Only two consecutive voltage tangent vector profiles are needed in the proposed formulation which involves less computational cost in comparisons with those required in existing methods. A numerical stable method to calculate the tangent vector will be proposed first. Based on the load margin approximations predicted by the tangent vector, a general framework for look-ahead contingency selection, evaluation, and ranking will be developed. We will evaluate the proposed method on several power systems. Simulation results will demonstrate the efficiency and the accuracy of the proposed method.

### SUMMARY OF THE INVENTION

The main objective of the present invention is to provide an efficient look-ahead load margin and voltage profiles contingency analysis that uses a tangent vector index method.

To achieve the objective, given the current operating condition at each bus from real-time database, from the short-term load forecast, or from near-term generation dispatch, we present a method for real-time contingency prediction and selection in current energy management systems. This method can be applied to contingency prediction and selection for the near-term power system in terms of load margins to collapse and of the bus voltage magnitudes. The propose algorithm uses only two tangent vectors of power flow solutions and curve fitting based techniques to perform look-ahead load margin and voltage magnitude simultaneously. Therefore, it can overcome the traditional snap-shot contingency analysis methods. Simulations are performed on IEEE 57 and 118-bus test systems to demonstrate the feasibility of this method.

Further benefits and advantages of the present invention will become apparent after a careful reading of the detailed description with appropriate reference to the accompanying drawings.

### BRIEF DESCRIPTION OF THE DRAWINGS

FIG. 1 shows a framework for look-ahead contingency selection, evaluation and ranking.

### DETAILED DESCRIPTION OF THE INVENTION

Voltage Collapse

Look-ahead contingencies are ranked according to their load margin to voltage collapse. To facilitate our analysis, we will use the following continuation power flow method [reference 4].
^{F}(x, λ)=f(x)+λb=0 (1)
where F(x,λ)=[P(x,λ),Q(x,λ)]^{T} is active and reactive power equations at each bus, x=[θ,V]^{T} represents bus angles and voltages. λ∉R is a controlling parameter. The vector b represents the variation of the real and reactive power demand at each bus.

Typically, a power system is operated at a stable solution. At the parameter λ varies, the number of load flow solutions will also change. When the stable solution and the unstable solution coalesce together, voltage instability would take place. Mathematically, this problem is to determine the maximum allowable parameter λ such that the system can remain stable. The point x. in the state space such that the system losses the stability is called the collapse point. x. is called the load margin with respect to the demand variation b. when voltage collapse occurs, the system Jacobian matrix

$$J ( x ) = \frac{θ}{{θ}_{x}} f ( x ) {\vert}_{x} .$$

is singular.

The voltage collapse point can also interpreted as a saddle-node bifurcation point in the context of the general nonlinear system theory [reference 8]. Indeed, at the collapse point, using linearlization techniques and Taylor series expansions, it has been shown that the load margin is a quadratic function of state variables x in general. Since we are only interested in the voltage magnitude near the collapse point after contingencies, it is reasonable to use the quadratic approximation in terms of the bus voltage [references 4 and 6]
λ=aVₖ²+bVₖ+c (2)
where k represents the bus number we are interested. Conventionally, the critical bus, which corresponds to the bus with the maximal voltage drop percentage, is chosen for the above approximation. The above formulas have been widely used for look-ahead contingency. In [reference 6], three power solutions are required to get the approximate load margin. In [reference 4], two power flow solutions plus one tangent vector, which will be explained later, are used to calculate the approximate load margin. We will develop a new approximate formula with less unknown coefficients in the next section.
TVI Index and Test Functions

More recently, the tangent voltage index method have been proposed to indicate the proximity of voltage instability [references 1 and 11-13]. The tangent vector index (TVI) at bus k is defined as

$${TVI}_{k} = \frac{1}{\vert \frac{ⅆ {V}_{k}}{ⅆ λ} \vert}$$

where

$$\frac{ⅆ {V}_{k}}{ⅆ λ}$$

is the k-th bus voltage in the tangent vector of the power flow equation (1). Obviously, as the collapse point is approached,

$$\frac{ⅆ {V}_{k}}{ⅆ λ} -> ∞$$

and TIVₖ will be close to zero. Using the chain rule, we have

$$\frac{ⅆ V}{ⅆ λ} = - {J}^{- 1} \frac{\partial F}{\partial λ} = - {J}^{- 1} b$$

Thus TVI can also be expressed as

$${TVI}_{k} = \frac{1}{\vert kth voltage component of {J}^{- 1} b \vert} = \frac{1}{\vert {e}_{h}^{T} {J}^{- 1} b \vert} \qquad ( 3 )$$

The above formulation indicates that the tangent vector can be viewed as a voltage sensitivity vector when the load/generator pattern is varied along the direction b. Consequently, the critical bus can be identified as the bus with the largest entry in the tangent vector TVI=[TVI₁, . . . TVIₙ]^{T}.

Although the TVI formulation in eq. (3) is theoretically correct, the calculation near the collapse point, which includes the inverse of the near-singular Jacobian matrix, may prevent to predict the collapse point exactly. Here an alternative scheme is developed. As shown in Appendix A, TVI in eq. (3) is mathematically equivalent to the absolute value of a new test function τ(x,λ):
τ(x,λ)=eₖ^{T}J(x,λ)Ĵₖb (4)
where eₖ is the k-th unit vector, Ĵ=(I−bb^{T})J+beₖ^{T} is a nonsingular matrix at the collapse point x· if b∉Range(J) and eₖ∉(Range(J^{T}). Thus, calculations of the TVI can be arranged as a byproduct of conventional power flow solvers. Note that when a change of real or reactive demand only occurs on a single bus, b=eₜ for some l. The new test function τ(x,λ) is exactly the same as the conventional test function of the form tₛ(x,λ)=eₗ^{T}J(x, λ)Jₗₖₑₗ, where Jₗₖ=(I−eₗeₗ^{T})J+eₗeₖ^{T} is nonsingular at the collapse point [references 3 and 8].

Seydel suggested that test function is expected to be a parabolic function symmetrical about the λ-axis [reference 9]. Since TVI is just a special case of test functions, the approximate collapse point predicted by TVI can utilize the following parabolic function in terms of only two unknown coefficients A and C.
λ=A(TVIₖ)²+C (5)
Although this approximation (5) is somewhat different from eq. (2), with some algebraic manipulations. It can be shown that eq. (5) can also be derived from eq. (2). The detailed proof can be found in Appendix B.

This new formula (5) also suggests that the predicted load margin λ. is equal to unknown coefficient C. Because only two unknown coefficients need to be determined, less computational cost will be involved in comparing with those required in [references 4 and 6].

The above formula can also contribute to the voltage profiles calculations at the collapse point. If TVI is expressed in terms of coefficients A and C, we have

$$\frac{1}{{TVI}_{k}} = \vert \frac{ⅆ {V}_{k}}{ⅆ λ} \vert = \sqrt{( C - λ ) A}$$

by integrating the above equation with respect to λ, the critical bus voltage V_{λ}. at the collapse point λ. can be approximated by the following formula:
Vₖ.=Vₖ−2\sqrt{A(λ−C)} (6)
Look-Ahead Contingency Analysis

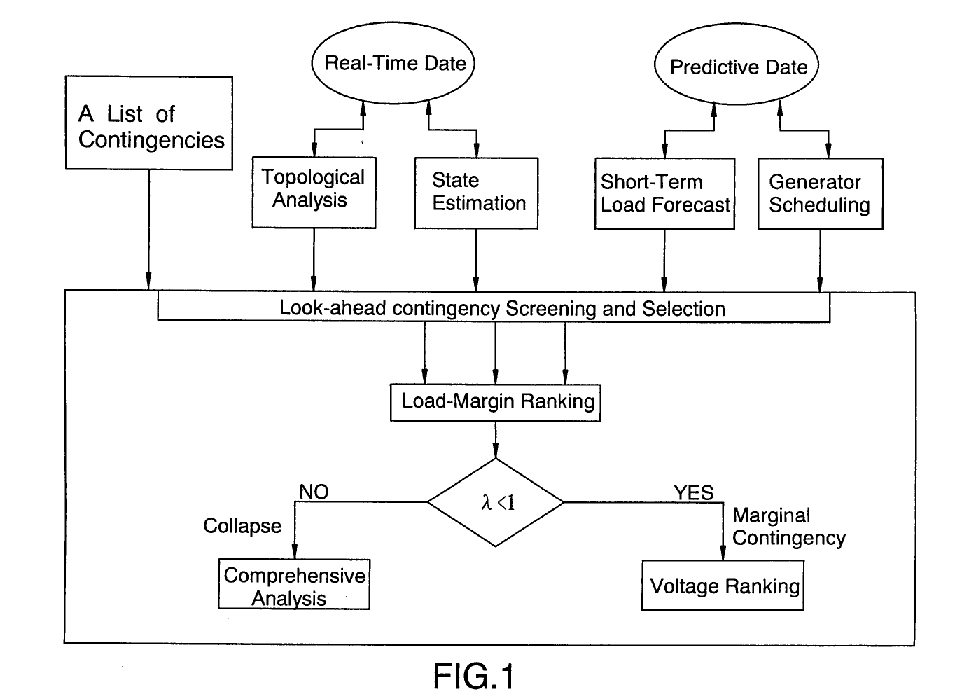

Having developed the approximation formula for load margins and voltage profiles, we will use these formulas to perform look-ahead contingency selections. The proposed method does not intend to calculate the exact voltage collapse point. Instead, it is expected to rank the near-term load margin and voltage profiles right after a given contingency. The proposed look-ahead contingency selection framework, shown in FIG. 1, is adopted from [reference 4]. The first filter uses the load margin information to select serve cases from a list of contingencies. If the predicted load margin is sufficiently small, the system has a great potential for voltage collapse due to this given contingency. Otherwise, if the load margin is sufficiently enough, the post-contingency system still operates in a stable equilibrium point. No voltage collapse will occur and the corresponding voltage profiles still remain feasible. Cases identified with large load margin will be sent to the second filter. The second filter will perform the voltage ranking. This voltage ranking will indicate the feasibility of near-term voltage profile after a given contingency. The computation procedure for load-margin ranking the voltage profile ranking is briefly discussed as follow:

Load-Margin Ranking

Given a near-term demand and generator schedule, the load margin can be predicted using the new TVI formula (4). Suppose that the critical bus at current load/generation level λ₁ is identified to be bus k. λ₂ is set to 1 which corresponds to the near-term load demand. TVI index TVI_{1,k} at current load/generation level λ₁ and the near-term TVI index TVI_{2,k} at load/generation level λ₂ are available, we use the quadratic curve eq. (5) to approximate the collapse point. Usually, A is set to 1. The values for unknown coefficients A and C can be calculated by solving the following linear equations:

$$[ \begin{matrix}{TVI}_{1 , k}^{2} 1 \\ {TVI}_{2 , k}^{2} 1\end{matrix} ] = [ \begin{matrix}A \\ C\end{matrix} ] = [ \begin{matrix}{λ}_{1} \\ {λ}_{2}\end{matrix} ] \qquad ( 7 )$$

The solution C is the approximate load margin λ. which roughly corresponds to the collapse point. Of cause, if the system state is relatively close the collapse point, the approximate margin will give very accurate result. One the other hand, when the post-contingency load margin λ. is less than 1, this contingency will cause voltage collapse before the system reach the forecasted load/generation level. On the other hand, if the load margin is sufficiently large, no voltage collapse will occur due to the given contingencies. Such contingency will be classified to be marginal contingency. These causes are mild contingencies and are required further voltage ranking.
Voltage Ranking

We do not give voltage ranking to the contingency whose λ. is less than 1. Voltage ranking will only be investigated in marginal contingency cases. Their ranks are examined from the associated λ−V curve of buses along the load/generation pattern b. In [reference 4], they suggested using the voltage profiles at the near-term load/generation level λ₂=1 to rank these marginal contingencies. Here we rank marginal contingencies using voltage profiles at the collapse point A by taking advantage of eq. (6). No additional power flow solutions are needed in this approximate formula (6).

Numerical Studies

The proposed algorithm has been tested and evaluated on several power systems. In this section, we will present simulation results on IEEE 57-bus and IEEE 118-bus power systems [reference 14]. In order to illustrate the severity of voltage collapse after possible contingencies, generation and load patterns at base case (λ=0) have been adjusted to heavy load conditions. Also, it is assumed the variance of the real and reactive power demand at each bus obtained from the near-term load forecasting is uniformly increasing. Like existing load margin indices, system operational constraints and physical limits, such as reactive power capability of generator and OLTC physical restrictions, are not considered. All simulation results shown here are obtained by modifying the continuation power flow program PFLOW [reference 15].

57-Bus System

The proposed method has been applied to this system with some single line outage contingencies. The simulation is started with the base load case. By using the tangent vector formulation at the case, the critical bus can be identified to be bus 31. Table 1 displays simulations results of several contingencies: (i) the exact load margin λ_{MAX}, obtained by using the PFLOW, (ii) the estimated load margin λₘₐₓ⁽¹⁾, obtained by applying the proposed algorithm where the TVI is calculated using the equivalent test function (4), and (iii) estimated load margin if λₘₐₓ⁽²⁾, obtained by applying the proposed algorithm where the TVI is calculated using (3). According to the value of the predicted load margin, all contingencies are classified into two types: severe contingency (λ<1), and marginal contingency (λ>1). The small relative error percentage of the load margin indicates that our proposed load margin index is very close to the exact load margin obtained by the continuation power flow program. Since there exists an ill-conditional problem in calculating λₘₐₓ⁽²⁾, the relative error percentage of the load margin are extremely high in some several contingencies (for example, faulted lines are 37-38 and 30-31). However, if we use the equivalent test function formula (3) to estimate the load margin λₘₐₓ⁽¹⁾, the resulting error of the load margin is less than 1%.

TABLE 1
The contingency ranking result for IEEE 57-bus system

| | |
|---|---|
| Load-Margin Index | Load-ahead voltage |

| Fault | | | | λ*⁽¹⁾ | λ*⁽¹⁾ | | λ*⁽²⁾ | Vₘₐₓ | Vₘₐₓ | | V*⁽¹⁾ | V*⁽¹⁾ | | λ*⁽²⁾ |
|---|---|---|---|---|---|---|---|---|---|---|---|---|---|---|
| Line | λₘₐₓ (CPF) | λₘₐₓ Rank | λ*⁽¹⁾ | Rank | Error % | λ*⁽²⁾ | Error % | (CPF) | Rank | V*⁽¹⁾ | Rank | Error % | λ*⁽²⁾ | Error % |
| 25-30 | 0.0580 | [1] | 0.0604 | [1] | 4.24% | 0.0604 | 4.24% | 0.5432 | | 0.6088 | | 12.07% | 0.6088 | 12.07% |
| 34-35 | 0.1327 | [2] | 0.1337 | [2] | 0.81% | 0.1337 | 0.81% | 0.6088 | | 0.6395 | | 5.04% | 0.6395 | 5.04% |
| 34-32 | 0.1333 | [3] | 0.1342 | [3] | 0.68% | 0.1342 | 0.68% | 0.6089 | | 0.6406 | | 5.21% | 0.6406 | 5.21% |
| 38197 | 0.3127 | [4] | 0.3412 | [4] | 7.56% | 0.3412 | 7.56% | 0.6605 | | 0.7274 | | 10.13% | 0.7274 | 10.13% |
| 37-38 | 0.4195 | [5] | 0.4144 | [5] | −1.21% | 0.8288 | 97.58% | 0.5670 | | 0.7141 | | 25.94% | 0.7141 | 25.94% |
| 36-37 | 0.5939 | [6] | 0.5939 | [6] | −0.01% | 0.5939 | −0.01% | 0.5495 | | 0.6585 | | 19.83% | 0.6585 | 19.83% |
| 30-31 | 0.7788 | [7] | 0.7830 | [7] | 0.54% | 7.8305 | 905.42% | 0.4930 | | 0.6897 | | 39.91% | −2.4057 | −587.97% |
| 28-39 | 0.8860 | [8] | 0.8632 | [8] | −2.57% | 0.8632 | −2.57% | 0.5029 | | 0.7439 | | 47.91% | 0.7439 | 47.91% |
| 8-9 | 1.0800 | 1 | 1.0658 | 1 | −1.31% | 1.0658 | −1.31% | 0.4336 | 1 | 0.4542 | 1 | 4.74% | 0.4542 | 4.74% |
| 27-38 | 1.1298 | 2 | 1.1199 | 2 | −0.88% | 1.1199 | −0.88% | 0.4848 | 15 | 0.4962 | 5 | 2.36% | 0.4962 | 2.36% |
| 22-23 | 1.1967 | 3 | 1.1855 | 3 | −0.93% | 1.1855 | −0.93% | 0.5057 | 21 | 0.5151 | 18 | 1.86% | 0.5151 | 1.86% |
| 31-32 | 1.2515 | 4 | 1.2356 | 4 | −1.27% | 1.2356 | −1.27% | 0.5014 | 20 | 0.5128 | 17 | 2.27% | 0.5128 | 2.27% |
| 22-38 | 1.3450 | 5 | 1.3229 | 5 | −1.64% | 1.3229 | −1.64% | 0.4908 | 18 | 0.5059 | 14 | 3.09% | 0.5059 | 3.09% |
| 24-26 | 1.3834 | 6 | 1.3612 | 9 | −1.61% | 1.3612 | −1.61% | 0.4869 | 17 | 0.5013 | 10 | 2.97% | 0.5013 | 2.97% |
| 26-27 | 1.3834 | 7 | 1.3611 | 8 | −1.61% | 1.3611 | −1.61% | 0.4869 | 16 | 0.5014 | 11 | 2.97% | 0.5014 | 2.97% |
| 46-47 | 1.3863 | 8 | 1.3443 | 6 | −3.03% | 1.3443 | −3.03% | 0.4610 | 2 | 0.4889 | 2 | 6.06% | 0.4889 | 6.06% |
| 14-46 | 1.3874 | 9 | 1.3449 | 7 | −3.06% | 1.3449 | −3.06% | 0.4610 | 3 | 0.4892 | 3 | 6.12% | 0.4892 | 6.12% |
| 23-24 | 1.4376 | 10 | 1.4063 | 11 | −2.18% | 1.4063 | −2.18% | 0.4999 | 19 | 0.5169 | 20 | 3.41% | 0.5169 | 3.41% |
| 10-51 | 1.4779 | 11 | 1.4008 | 10 | −5.22% | 1.4008 | −5.22% | 0.4683 | 6 | 0.5233 | 22 | 11.74% | 0.5233 | 11.74% |
| 13-49 | 1.4925 | 12 | 1.4423 | 12 | −3.37% | 1.4423 | −3.37% | 0.4627 | 4 | 0.4914 | 4 | 6.19% | 0.4914 | 6.19% |
| 44-45 | 1.5159 | 13 | 1.4606 | 13 | −3.64% | 1.4606 | −3.64% | 0.4693 | 7 | 0.5002 | 9 | 6.58% | 0.5002 | 6.58% |
| 15-45 | 1.5174 | 14 | 1.4650 | 14 | −3.45% | 1.4650 | −3.45% | 0.4694 | 8 | 0.4991 | 7 | 6.33% | 0.4991 | 6.33% |
| 38-48 | 1.5397 | 15 | 1.4869 | 15 | −3.43% | 1.4869 | −3.43% | 0.4711 | 9 | 0.499 | 6 | 5.93% | 0.4990 | 5.93% |
| 41-42 | 1.5810 | 16 | 1.5203 | 16 | −3.84% | 1.5203 | −3.84% | 0.4819 | 14 | 0.5196 | 21 | 7.83% | 0.5196 | 7.83% |
| 38-44 | 1.6001 | 17 | 1.5427 | 17 | −3.85% | 1.5427 | −3.58% | 0.4736 | 12 | 0.5035 | 12 | 6.31% | 0.5035 | 6.31% |
| 12-13 | 1.6160 | 18 | 1.5522 | 20 | −3.94% | 1.5522 | −3.94% | 0.4675 | 5 | 0.4996 | 8 | 3.87% | 0.4996 | 6.87% |
| 47-48 | 1.6166 | 19 | 1.5517 | 19 | −4.02% | 1.5517 | −4.02% | 0.4726 | 11 | 0.505 | 13 | 6.86% | 0.5050 | 6.86% |
| 11-43 | 1.6238 | 20 | 1.5442 | 18 | −4.90% | 1.5442 | −4.90% | 0.4718 | 10 | 0.5162 | 19 | 9.42% | 0.5162 | 9.42% |
| 52-53 | 1.6468 | 21 | 1.7003 | 22 | −3.25% | 1.7003 | 3.25% | 0.6039 | 22 | 0.5124 | 16 | −15.15% | 0.5124 | −15.15% |
| Normal | 1.7752 | 22 | 1.6945 | 21 | −4.55% | 1.6945 | −4.55% | 0.4845 | 13 | 0.5106 | 15 | 7.61% | 0.5106 | 7.61% |

We also evaluate the voltage profile of the critical bus (bus 31) at the collapse point using the formula. The resulting relative error of the voltage magnitude is shown in column 5. We can find that in most marginal contingency cases, the error percentage between the predicted voltage magnitude and the exact voltage magnitude is less than 8%. This simulation results show that the predicted voltage profiles give fairly accurate results. Note that there are some differences between the ranking results by the exact method and our proposed method. This is because that some contingencies are very mild in the sense that voltage variations are very small. The exact ranking seems to be insignificant for security analysis.

118-Bus System

additional numerical experiments were conducted using a IEEE 118-bus test system. After the base case power flow is performed, it can be found that the critical bus is located at bus 44. Table 2 shows simulation results with several contingencies. The ranking results of these contingencies produced by using the exact method and the proposed method are also shown in this table. Similar to results obtained from IEEE 57-bus system, we found that our predicted load margin index provides accurate results both for voltage collapse and mild contingency cases.

TABLE 2
The contingency ranking result for IEEE 118-bus system

| | Load-Margin Index | | | | | | | Load-ahead voltage | | | | | | |
|---|---|---|---|---|---|---|---|---|---|---|---|---|---|---|
| Fault | λₘₐₓ | λₘₐₓ | | λ*⁽¹⁾ | λ*⁽¹⁾ | | λ*⁽²⁾ | Vₘₐₓ | Vₘₐₓ | | V*⁽¹⁾ | V*⁽¹⁾ | | λ*⁽²⁾ |
| Line | (CPF) | Rank | λ*⁽¹⁾ | Rank | Error % | λ*⁽²⁾ | Error % | (CPF) | Rank | V*⁽¹⁾ | Rank | Error % | λ*⁽²⁾ | Error % |
| 26-30 | 0.8355 | [1] | 0.7804 | [1] | −6.60% | 0.7804 | −6.60% | 0.7707 | | 0.9081 | | 17.83% | 0.9081 | 17.83% |
| 42-49 | 0.9075 | [2] | 0.8299 | [2] | −8.55% | 0.8299 | −8.55% | 0.7486 | | 0.9095 | | 21.49% | 0.9095 | 21.49% |
| 25-27 | 0.9629 | [3] | 0.9390 | [3] | −2.48% | 0.9390 | −2.48% | 0.7592 | | 0.9177 | | 20.87% | 0.9177 | 20.87% |
| 11-13 | 0.9763 | [4] | 1.0402 | [4] | 6.55% | 1.0402 | 6.55% | 0.8185 | | 0.8746 | | 6.86% | 0.8746 | 6.86% |
| 23-32 | 1.0450 | 1 | 1.0327 | 2 | −1.18% | 1.0327 | −1.18% | 0.7261 | 17 | 0.7460 | 22 | 2.74% | 0.7460 | 2.74% |
| 65-68 | 1.0454 | 2 | 1.1318 | 18 | 8.26% | 1.1318 | 8.26% | 0.8067 | 22 | 0.7313 | 9 | −9.35% | 0.7313 | −9.35% |
| 30-17 | 1.0541 | 3 | 1.0271 | 1 | −2.56% | 1.0271 | −2.56% | 0.6907 | 13 | 0.7347 | 16 | 6.37% | 0.7347 | 6.37% |
| 41-42 | 1.0660 | 4 | 1.1175 | 16 | 4.82% | 1.1175 | 4.82% | 0.6594 | 3 | 0.7284 | 4 | 10.46% | 0.7284 | 10.46% |
| 44-45 | 1.0835 | 5 | 1.1017 | 9 | 1.68% | 1.1017 | 1.68% | 0.6256 | 2 | 0.5684 | 1 | −9.14% | 0.5684 | −9.14% |
| 37-39 | 1.0866 | 6 | 1.1294 | 17 | 3.93% | 1.1294 | 3.93% | 0.7817 | 21 | 0.7444 | 21 | −4.77% | 0.7444 | −4.77% |
| 34-37 | 1.1087 | 7 | 1.0608 | 3 | −4.33% | 1.0608 | −4.33% | 0.6606 | 4 | 0.7135 | 3 | 8.01% | 0.7135 | 8.01% |
| 37-40 | 1.1264 | 8 | 1.1472 | 22 | 1.85% | 1.1472 | 1.85% | 0.7604 | 19 | 0.7376 | 19 | −3.00% | 0.7376 | −3.00% |
| 30-38 | 1.1321 | 9 | 1.0993 | 7 | −2.90% | 1.0993 | −2.90% | 0.7059 | 16 | 0.7360 | 17 | 4.27% | 0.7360 | 4.27% |
| 45-49 | 1.1324 | 10 | 1.0827 | 4 | −4.39% | 1.0827 | −4.39% | 0.5503 | 1 | 0.6376 | 2 | 15.86% | 0.6376 | 15.86% |
| 22-23 | 1.1328 | 11 | 1.0887 | 5 | −3.89% | 1.0887 | −3.89% | 0.6899 | 12 | 0.7339 | 14 | 6.38% | 0.7339 | 6.38% |
| 77-78 | 1.1359 | 12 | 1.1430 | 20 | 0.63% | 1.1430 | 0.63% | 0.7612 | 20 | 0.7287 | 5 | −4.26% | 0.7287 | −4.26% |
| 8-30 | 1.1384 | 13 | 1.1007 | 8 | −3.31% | 1.1007 | −3.31% | 0.6998 | 15 | 0.7373 | 18 | 5.36% | 0.7373 | 5.36% |
| 69-70 | 1.1415 | 14 | 1.0946 | 6 | −4.11% | 1.0946 | −4.11% | 0.6848 | 5 | 0.7293 | 7 | 6.50% | 0.7293 | 6.50% |
| 21-22 | 1.1497 | 15 | 1.1040 | 12 | −3.97% | 1.1040 | −3.97% | 0.6891 | 11 | 0.7323 | 10 | 6.27% | 0.7323 | 6.27% |
| 23-24 | 1.1501 | 16 | 1.1107 | 13 | −3.42% | 1.1107 | −3.42% | 0.6992 | 14 | 0.7358 | 20 | 5.63% | 0.7358 | 5.63% |
| 15-17 | 1.1511 | 17 | 1.1030 | 10 | −4.18% | 1.1030 | −4.18% | 0.6874 | 7 | 0.7324 | 11 | 6.55% | 0.7324 | 6.55% |
| 17-18 | 1.1517 | 18 | 1.1039 | 11 | −4.15% | 1.1039 | −4.15% | 0.6883 | 10 | 0.7334 | 13 | 6.55% | 0.7334 | 6.55% |
| 39-40 | 1.1561 | 19 | 1.1470 | 21 | −0.79% | 1.1470 | −0.79% | 0.7339 | 18 | 0.7340 | 15 | 0.02% | 0.7340 | 0.02% |
| 4-5 | 1.1654 | 20 | 1.1156 | 14 | −4.27% | 1.1156 | −4.27% | 0.6875 | 8 | 0.7329 | 12 | 6.60% | 0.7329 | 6.60% |
| 70-71 | 1.1659 | 21 | 1.1174 | 15 | −4.16% | 1.1374 | −4.16% | 0.6875 | 9 | 0.7308 | 8 | 6.30% | 0.7308 | 6.30% |
| Normal | 1.1893 | 22 | 1.1399 | 19 | −4.15% | 1.1399 | −4.15% | 0.6870 | 6 | 0.7292 | 6 | 6.14% | 0.7292 | 6.14% |

### CONCLUSION

Given the current operating condition, and the near-term load forecasting and/or generation rescheduling information, we have presented a new method to predict load margin and the voltage profile after contingency. The techniques we used here is the tangent vector index. In order to avoid the ill-conditional problems associate with conventional TVI calculations, an equivalent test function of TVI is proposed. Based on the collapse point characteristics and TVI, a new efficient curve-fitting-based algorithm will be developed for look-ahead contingency analysis. Due to the simplicity of our calculation scheme, this method can easily integrate into current contingency analysis environments and enhance its look-ahead capability.

Appendix A

In the appendix, we will show the equivalent relationship between the TVI index and the new class of test function. First, let's recall the following lemma: Lemma 1: for a square matrix A of size n and rank n-1, let the right null vector be denoted by h and the left null vector by g,g^{T}h≈0. Now define an augmented matrix

$$H = [ \begin{matrix}A & b \\ {C}^{T} & ζ\end{matrix} ]$$

with ∥b∥=1. The following statements are equivalent [10]:
1. H is nonsingular
2. b∉Range (A) and c∉(Range(A^{T})
3. g^{T}b≈0 and c^{T}h≈0
4. (I−bb^{T})A+bc^{T} is of rank n.

Now we are in a position to prove the equivalence of eq. (3) and eq. (4). If b∉Range(J) and eₖ∉Range(J^{T}), we can define a class of new test function r(x, A) as
τ(x,λ)=b^{T}JĴ_{bk}⁻¹b
Matrix Ĵₖ denotes Ĵ=(I−bb^{T})J+beₖ^{T}. By Lemma 1, Ĵₖ is nonsingular at the collapse point. Suppose that v is the solution of the linear equation Jᵥ=b
Ĵₖv=(I−bb^{T})Jv+beₖ^{T}v=(I−bb^{T})b+bvₖ=bvₖ
where vₖ represents the k-th entry in v. Hence,
JĴₖ⁻¹bvₖ=Jv=b
Multiplying both sides by b^{T} and taking the absolute value yields

$$\vert τ ( x , λ ) \vert = \vert {b}^{T} J {\hat{J}}_{bk}^{- 1} b \vert = \vert \frac{1}{{v}_{k}} \vert = {TVI}_{k}$$

Therefore, |τ(x, λ)| is another expression for the TVI index.
Appendix B

In this appendix, the relationship of unknown coefficients between eq. (2) and eq. (5) will be derived. First, by taking the derivative of λwith respect to vₖ, we have

$$\frac{1}{{TVI}_{k}} = \frac{ⅆ λ}{{( ⅆ V )}_{k}} = 2 {aV}_{k} + b$$

The values of unknown A and C can be expressed in terms of a, b and c if we substitute the above equality into eq. (5). Thus,

$$A = \frac{1}{4 a} , C = c - \frac{{b}^{2}}{4 a} \qquad ( 8 )$$

This complete our proof

### REFERENCE

[1] C A Canizares, A. C. Z. de Souza, and V. H Quintana, “Comparison of performance indices for detection of proximity to voltage collapse”, IEEE Trans. On Power systems, vol. 11, No. 3, pp. 1441-1450, August 1996.
[2] Y L. Chen and A. Bose, “Direct ranking voltage contingency selection”, IEEE Trans. On Power System, vol. 4, No. 4, pp. 1335-1344, October 1989.
[3] H. D. Chiang and R. Jean-Jumeau, “Toward a practical performance index for predicting voltage collapse in electric power systems”, IEEE Trans. On Power System, vol. 10, no. 2, pp. 584-592, May 1995.
[4] H. D. Chiang, C S Wang and A J. Flueck, “Look-ahead voltage and load margin contingency selection functions for large-scale power system”, IEEE Trans, on Power System, vol. 12, no. 1, pp. 173-180, February 1997.
[5] G C. Ejejb, P. Van Meeteren, and B. F. Wollenberg, “Fast contingency and evaluation for voltage security analysis”, IEEE trans, on Power System, vol. 3, no. 4, pp. 1582-1920, November 1988.
[6] G C. Ejebe, G D. Irisarri, S. Mokhhtari, O. Obadina, P. Ristanovic, and J. Tong, “Methods for contingency screening and ranking for voltage stability analysis of power systems”, IEEE Trans, on Power System, vol. 11, no. 1, pp. 350-356, February 1996.
[7] S. Greene, I. Dobson, and F. L. Alvarado, “Contingency ranking for voltage collapse via sensitivities from a single nose curve”, IEEE Engineering Society Summer Meeting.
[8] R Seydel, Practical Bifurcation and Stability Analysis: From Equilibrium to Chaos, Spring-Verlag, New York, 1994.
[9] R Seydel, “On detecting stationary bifurcations”, Int. J. Bifurcation and Chaos, vol. 1, pp. 335-337, 991.
[10] R. Seydel, “On a class of bifurcation test function”, Chaos, Saluations, Fractals, vol. 8, no. 6, pp. 851-855, 1997.
[11] A. C. Zambroni De Souza and N. H. M. N. Brito, “Voltage collapse and control actions, Effects and limitation”, electric Machines and Power System, pp. 903-915, 1998.
[12] A. C. Zambroni De Souza, C. A. Canizares, and V. H. Quintana, “New techniques to speed up voltage collapse computations using tangent vectors”, IEEE Trans, on Power Systems, vol. 12, no. 3, pp. 1380-1387, August 1997.
[13] A. C. Zambroni De Souza, “Tangent vector applied to voltage collapse and loss sensitivity studies”, Electric Power Systems Research, vol. 47, pp 65-70, 1998.
[14] Data available via ftp at wahoo.ee.washington edu.
[15] Software available via ftp at iliniza uwaterloo.ca in sundirectory pub/pflow.

What is claimed is:

1. An efficient look-ahead load margin and voltage profiles contingency analysis that uses a tangent vector index method comprising the steps of:
calculating a current between two points after contingency; and
estimating a voltage of a collapse point by using curve of the second degree and tangent vector.

2. The method as claimed in claim 1, wherein to estimate the voltage of the collapse point comprises the steps of:
using the value from continuation current to estimate the collapse point after contingency; and
calculating a new tangent vector in a new work point and repeating the steps till the error within a purposed range.
